(19) United States
(12) Patent Application Publication
(10) Pub. No.: US 2013/0203292 A1
(43) Pub. Date: Aug. 8, 2013

(54) ELECTRICAL CONNECTOR WITH A BUILT-IN SIGNAL GAIN CIRCUIT

(71) Applicant: Nai-Chien CHANG, New Taipei City (TW)

(72) Inventor: Nai-Chien CHANG, New Taipei City (TW)

(21) Appl. No.: 13/749,301

(22) Filed: Jan. 24, 2013

(30) Foreign Application Priority Data
Feb. 7, 2012 (TW) 101202230

(51) Int. Cl. H01R 13/66

(52) U.S. Cl. CPC H01R 13/6691
USPC 439/620.01

(57) ABSTRACT

An electrical connector includes a casing, a housing, a terminal set, a printed circuit board, a cover body, and a signal gain circuit. The signal gain circuit is electrically connected to the printed circuit board and arranged on the printed circuit board. The electrical connector is arranged at a front panel of a computer and is electrically connected to an external electronic apparatus. Signals transmitted between the computer and the external electronic apparatus will not be weakened because of the signal gain circuit.

This application is based on and claims the benefit of Taiwan Application No. 101202230 filed Feb. 7, 2012 the entire disclosure of which is incorporated by reference herein.

### BACKGROUND OF THE INVENTION

1. Field of the Invention

The present invention relates to an electrical connector, and especially relates to an electrical connector with a built-in signal gain circuit.

2. Description of the Related Art

A mainboard is arranged in a casing of a computer after a lot of electrical connectors are electrically connected to the mainboard. The electrical connectors are usually arranged at the back side of the casing of the computer. Therefore, plugging (unplugging) an external electronic device into (from) the electrical connector is inconvenient.

Therefore, a computer expansion module, such as a computer front panel, is invented. The computer front panel mainly includes a front printed circuit board. An audio output interface hole, a microphone input interface hole, and USB electrical connectors are integrated on the front printed circuit board. The front printed circuit board is electrically connected to the mainboard of the computer through a bus.

Some USB devices, such as USB flash drives, are directly plugged into the USB electrical connectors on the front printed circuit board through USB connectors of the USB flash drives. The other USB devices, such as external CD-ROM drives and external hard drives, are electrically connected to the USB electrical connectors on the front printed circuit board through extra transmission lines (namely, extension lines). The length of the bus for electrically connecting the front printed circuit board and the mainboard is usually long. The length of the bus pluses the length of the extra transmission line may exceed the specification of the USB transmission distance if the length of the extra transmission line is long as well. Moreover, there are usually many electrical contacts in the computer. Signals and data may be weakened, distorted or lost during transmission process if the signal transmission distance is too long or there are too many electrical contacts in the computer.

### SUMMARY OF THE INVENTION

In order to solve the above-mentioned problems, an object of the present invention is to provide an electrical connector with a built-in signal gain circuit. Therefore, the signals will not be weakened, distorted or lost during transmission process even if the signal transmission distance is too long or there are too many electrical contacts in the computer.

In order to achieve the object of the present invention mentioned above, the electrical connector includes a casing, a housing, a terminal set, and a printed circuit board. The casing includes a hollow main body. The hollow main body includes an insertion port at a front end of the hollow main body. The hollow main body includes an opening. The opening is arranged at a rear end of the hollow main body and a bottom part of the hollow main body. The housing is arranged inside the casing. The housing includes a hollow opening. The hollow opening is arranged at a rear end of the housing and a bottom part of the housing. The terminal set includes a plurality of conductive pins. The terminal set is arranged at the housing. One side of the conductive pin is extended outside the hollow opening. The printed circuit board is electrically connected to the conductive pin. The electrical connector further includes a signal gain circuit electrically connected to the printed circuit board and arranged on the printed circuit board.

The casing is made of metal. The casing includes a plurality of baffle plates. The baffle plate is in arc-shaped and is arranged around the insertion port. The housing is made of plastic. The housing includes a baffle wall arranged at a front end of the housing. The housing includes a tongue plate extended from the baffle wall. The baffle wall includes a plurality of perforations. The terminal set passes through the perforations. Therefore, one side of the conductive pin of the terminal set is extended to the tongue plate. Moreover, the housing includes two walls opposite to each other. Each of the walls includes at least a recession part. The recession part of one of the walls is opposite to the recession part of the other wall. The conductive pin includes a first section pin and a second section pin. The first section pin is in flat-shaped or arc-shaped and is arranged on the tongue plate. The second section pin is in L-shaped and is arranged at the perforation. The printed circuit board includes a plurality of inserting holes at one side of the printed circuit board. One side of the second section pin is inserted into the printed circuit board through the inserting hole and is electrically connected to the printed circuit board. The electrical connector includes a plurality of conductive legs arranged at another side of the printed circuit board. The electrical connector is applied to a computer having a mainboard. The conductive leg is electrically connected to the mainboard of the computer. The electrical connector further includes an L-shaped cover body made of plastic. The cover body includes a first cover plate and a second cover plate. The first cover plate includes a plurality of via holes. The conductive legs pass through the via holes. The first cover plate includes a plurality of bumps opposite to the recession parts. The signal gain circuit is a semiconductor chip or a linear circuit. The electrical connector is applied to a front apparatus having a front printed circuit board. The electrical connector is electrically connected to the front printed circuit board of the front apparatus. The electrical connector is applied to a transmission interface and a bus. The front printed circuit board is electrically connected to the transmission interface. The bus is plugged into the transmission interface. The electrical connector is one of the universal serial bus 2.0 (USB 2.0), universal serial bus 3.0 (USB 3.0), external serial advanced technology attachment (eSATA), institute of electronical and electronic engineers 1394 (IEEE 1394), high definition multimedia interface (HDMI), and displayport.

### BRIEF DESCRIPTION OF DRAWING

FIG. 1 shows an exploded view of the electrical connector of the present invention.

FIG. 2 shows a bottom view of the electrical connector of the present invention.

FIG. 3 shows another view of the electrical connector of the present invention.

FIG. 4 shows a side cross-sectional view of the electrical connector of the present invention.

FIG. 5 shows a block diagram of the connections of the electrical connector, the signal gain circuit, the front printed circuit board, and the mainboard.

FIG. 6 shows a diagram showing how the electrical connector is applied.

FIG. 7 shows a side cross-sectional view of FIG. 6.

FIG. 8 shows another diagram showing how the electrical connector is applied.

FIG. 9 shows another diagram showing how the electrical connector is applied.

### DETAILED DESCRIPTION OF THE INVENTION

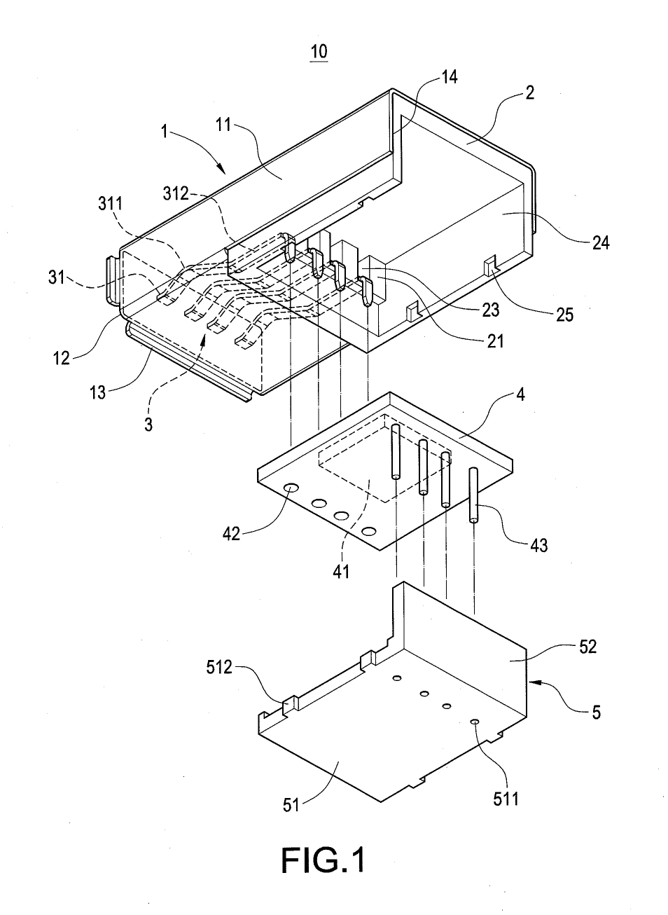

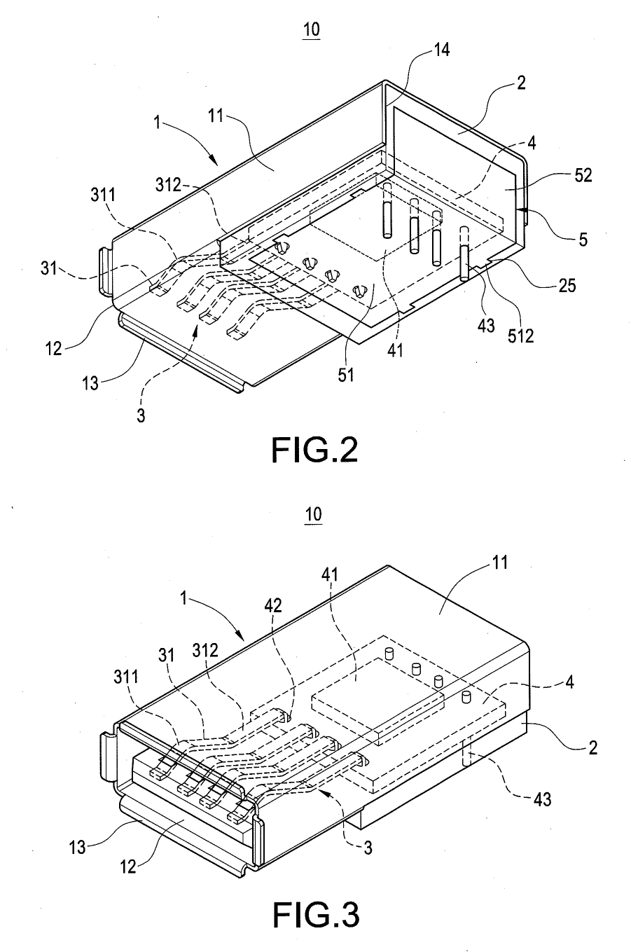

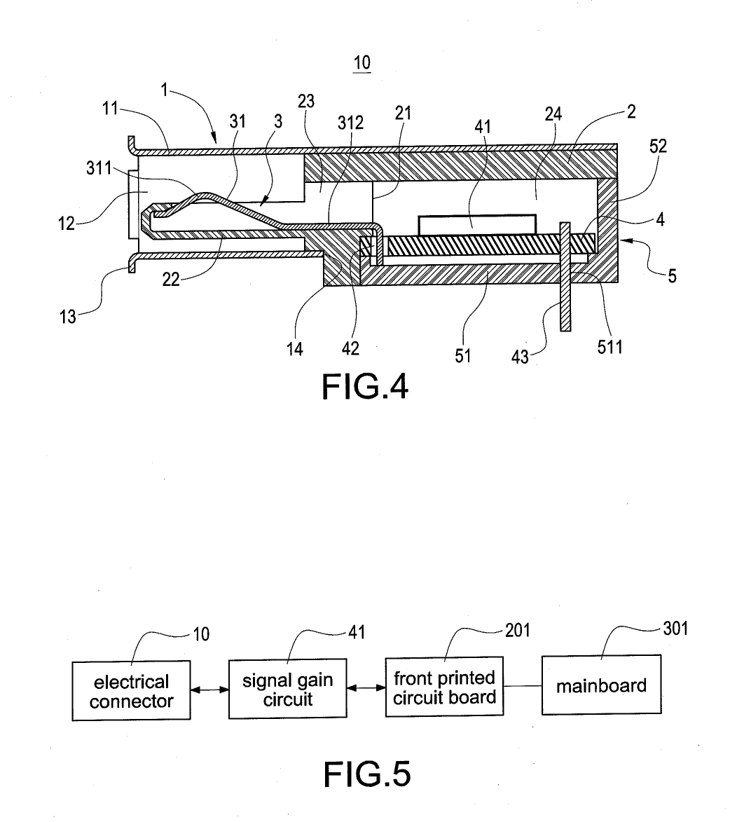

FIG. 1 shows an exploded view of the electrical connector of the present invention. FIG. 2 shows a bottom view of the electrical connector of the present invention. FIG. 3 shows another view of the electrical connector of the present invention. FIG. 4 shows a side cross-sectional view of the electrical connector of the present invention. An electrical connector 10 includes a casing 1, a housing 2, a terminal set 3, a printed circuit board 4, and a cover body 5.

The casing 1 is made of metal. The casing 1 includes a hollow main body 11. The hollow main body 11 includes an insertion port 12 at a front end of the hollow main body 11. The casing 1 includes a plurality of baffle plates 13. The baffle plate 13 is in arc-shaped and is arranged around the insertion port 12. The hollow main body 11 includes an opening 14. The opening 14 is arranged at a rear end of the hollow main body 11 and a bottom part of the hollow main body 11.

The housing 2 is made of plastic. The housing 2 is arranged inside the casing 1. The housing 2 includes a baffle wall 21 arranged at a front end of the housing 2. The housing 2 includes a tongue plate 22 extended from the baffle wall 21. The baffle wall 21 includes a plurality of perforations 23. The terminal set 3 passes through the perforations 23. Therefore, one side of a conductive pin 31 of the terminal set 3 is extended to the tongue plate 22. Moreover, the housing 2 includes a hollow opening 24. The hollow opening 24 is arranged at a rear end of the housing 2 and a bottom part of the housing 2. The housing 2 includes two walls opposite to each other. Each of the walls includes at least a recession part 25. The recession part 25 of one of the walls is opposite to the recession part 25 of the other wall.

The terminal set 3 includes a plurality of the conductive pins 31. The conductive pin 31 includes a first section pin 311 and a second section pin 312. The first section pin 311 is in flat-shaped or arc-shaped and is arranged on the tongue plate 22. The second section pin 312 is in L-shaped and is arranged at the perforation 23. One side of the first section pin 311 is extended outside the hollow opening 24.

The electrical connector 10 further includes a signal gain circuit 41 electrically connected to the printed circuit board 4 and arranged on the printed circuit board 4. Because of the signal gain circuit 41, signals will not be weakened during transmission process even if the signal transmission distance is long. The printed circuit board 4 includes a plurality of inserting holes 42 at one side of the printed circuit board 4. One side of the second section pin 312 is inserted into the printed circuit board 4 through the inserting hole 42 and is electrically connected to the printed circuit board 4. The electrical connector 10 includes a plurality of conductive legs 43 arranged at another side of the printed circuit board 4. The electrical connector 10 is applied to a computer having a mainboard. The conductive leg 43 is electrically connected to the mainboard of the computer. The signal gain circuit 42 is a semiconductor chip or a linear circuit.

The cover body 5 is made of plastic in L-shaped. The cover body 5 includes a first cover plate 51 and a second cover plate 52. The first cover plate 51 includes a plurality of via holes 511. The conductive legs 43 pass through the via holes 511. The first cover plate 51 includes a plurality of bumps 512 opposite to the recession parts 25. The conductive leg 43 passes through the via hole 511 of the first cover plate 51 when the cover body 5 is assembled to the hollow opening 24. Therefore, the bumps 512 opposite to the recession parts 25 will joint to the recession parts 25.

FIG. 5 shows a block diagram of the connections of the electrical connector, the signal gain circuit, the front printed circuit board, and the mainboard. The electrical connector 10 includes the signal gain circuit 41. The signal gain circuit 41 is electrically fixedly connected to a front printed circuit board 201. The front printed circuit board 201 is electrically connected to a mainboard 301. The signal gain circuit 41 will prevent the transmission signals from being weakened even if the signal transmission distance is long.

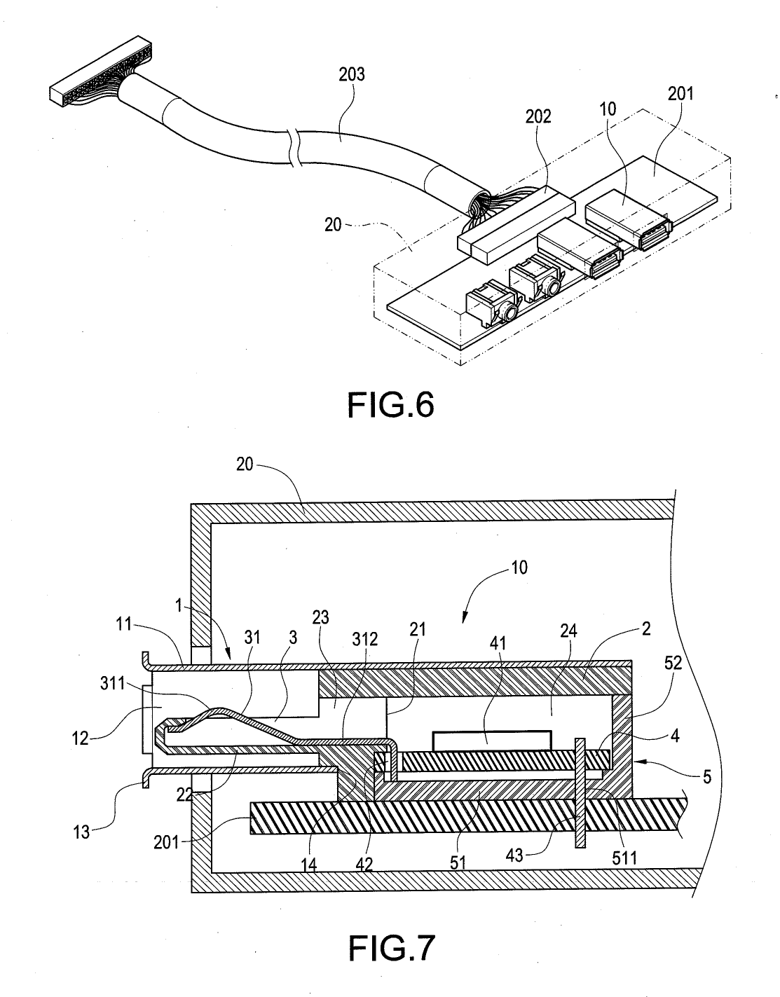

FIG. 6 shows a diagram showing how the electrical connector is applied. FIG. 7 shows a side cross-sectional view of FIG. 6. The electrical connector 10 is applied to a front apparatus 20 having the front printed circuit board 21. The electrical connector 10 is electrically connected to the front printed circuit board 201 of the front apparatus 20. The electrical connector 10 is applied to a transmission interface 202 and a bus 203. The front printed circuit board 201 is electrically connected to the transmission interface 202. The bus 203 is plugged into the transmission interface 202. The bus 203 is electrically connected to the mainboard 301. Therefore, the signals will not be weakened during transmission process even if the signal transmission distance is too long or there are too many electrical contacts in the computer.

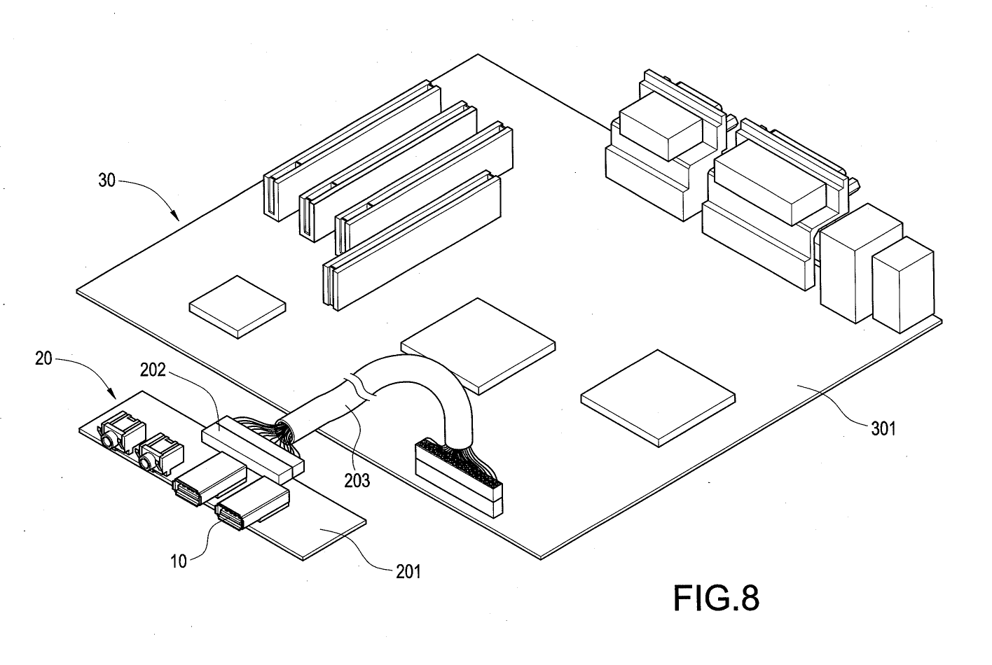

FIG. 8 shows another diagram showing how the electrical connector is applied. The electrical connector 10 is electrically connected to the front printed circuit board 201 of the front apparatus 20 without a casing. The front printed circuit board 201 is electrically connected to the transmission interface 202. The bus 203 is plugged into the transmission interface 202. The bus 203 is electrically connected to the mainboard 301 of a computer 30. Therefore, the signals will not be weakened during transmission process even if the signal transmission distance is too long or there are too many electrical contacts in the computer 30.

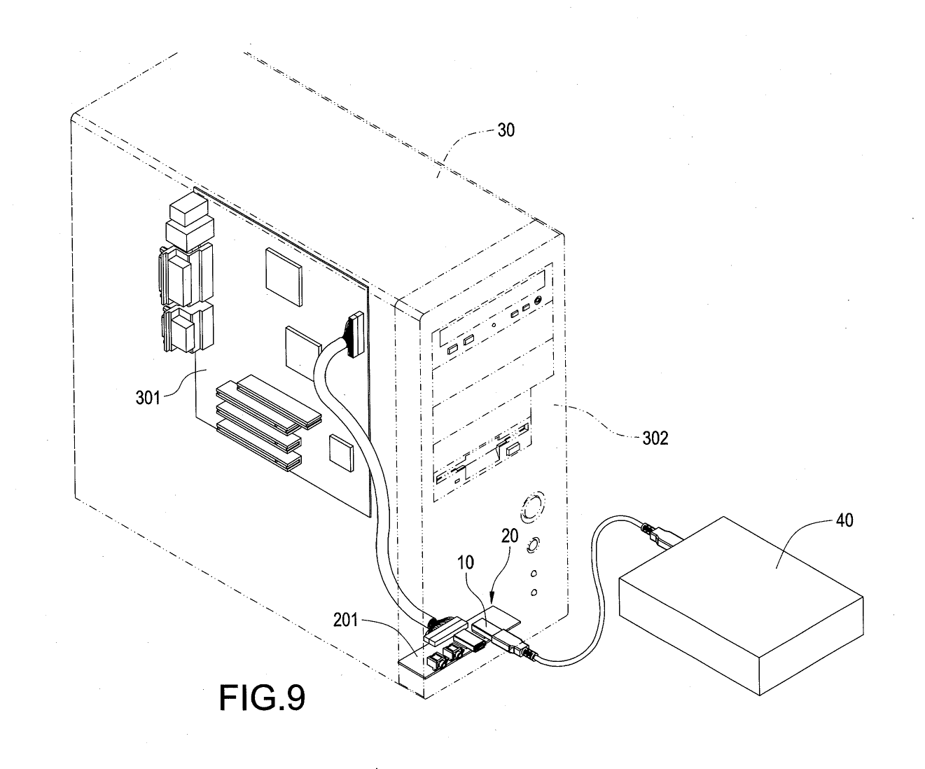

FIG. 9 shows another diagram showing how the electrical connector is applied. The front printed circuit board 201 of the front apparatus 20 is arranged at a front panel 302 of the computer 30. The bus 203 is plugged into the mainboard 301. The signals transmitted between the mainboard 301 and an external electronic apparatus 40 will not be weakened because the electrical connector 10 includes the signal gain circuit 41.

Moreover, the electrical connector 10 is one of the universal serial bus 2.0 (USB 2.0), universal serial bus 3.0 (USB 3.0), external serial advanced technology attachment (eSATA), institute of electronical and electronic engineers 1394 (IEEE 1394), high definition multimedia interface (HDMI), and displayport.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electrical connector including:
a casing having a hollow main body, the hollow main body including an insertion port at a front end of the hollow main body, the hollow main body including an opening, the opening arranged at a rear end of the hollow main body and a bottom part of the hollow main body;
a housing arranged inside the casing, the housing including a hollow opening, the hollow opening arranged at a rear end of the housing and a bottom part of the housing;
a terminal set including a plurality of conductive pins, the terminal set arranged at the housing, one side of the conductive pin extended outside the hollow opening; and
a printed circuit board electrically connected to the conductive pin, the electrical connector further including a signal gain circuit electrically connected to the printed circuit board and arranged on the printed circuit board.

2. The electrical connector in claim 1, wherein the casing is made of metal.

3. The electrical connector in claim 2, wherein the casing includes a plurality of baffle plates;
the baffle plate is in arc-shaped and is arranged around the insertion port.

4. The electrical connector in claim 3, wherein the housing is made of plastic.

5. The electrical connector in claim 4, wherein the housing includes a baffle wall arranged at a front end of the housing; the housing includes a tongue plate extended from the baffle wall; the baffle wall includes a plurality of perforations; the terminal set passes through the perforations;
one side of the conductive pin of the terminal set is extended to the tongue plate; the housing includes two walls opposite to each other; each of the walls includes at least a recession part; the recession part of one of the walls is opposite to the recession part of the other wall.

6. The electrical connector in claim 5, wherein the conductive pin includes a first section pin and a second section pin; the first section pin is in flat-shaped or arc-shaped and is arranged on the tongue plate; the second section pin is in L-shaped and is arranged at the perforation.

7. The electrical connector in claim 6, wherein the printed circuit board includes a plurality of inserting holes at one side of the printed circuit board; one side of the second section pin is inserted into the printed circuit board through the inserting hole and is electrically connected to the printed circuit board; the electrical connector further includes a plurality of conductive legs arranged at another side of the printed circuit board; the electrical connector is applied to a computer having a mainboard; the conductive leg is electrically connected to the mainboard of the computer.

8. The electrical connector in claim 7, further including an L-shaped cover body made of plastic, the cover body including a first cover plate and a second cover plate, the first cover plate including a plurality of via holes, the conductive legs passing through the via holes, the first cover plate including a plurality of bumps opposite to the recession parts.

9. The electrical connector in claim 8, wherein the signal gain circuit is a semiconductor chip or a linear circuit.

10. The electrical connector in claim 9, wherein the electrical connector is applied to a front apparatus having a front printed circuit board; the electrical connector is electrically connected to the front printed circuit board of the front apparatus; the electrical connector is applied to a transmission interface and a bus; the front printed circuit board is electrically connected to the transmission interface; the bus is plugged into the transmission interface.

11. The electrical connector in claim 10, wherein the electrical connector is one of the universal serial bus 2.0 (USB 2.0), universal serial bus 3.0 (USB 3.0), external serial advanced technology attachment (eSATA), institute of electronical and electronic engineers 1394 (IEEE 1394), high definition multimedia interface (HDMI), and displayport.
